(19) United States
(12) Patent Application Publication
(10) Pub. No.: US 2003/0174668 A1
(43) Pub. Date: Sep. 18, 2003

(54) Method for controlling access in a radio communications system

(76) Inventors: Christina Gessner, Munchen (DE); Andreas Huynck, Hohen Neuendorf (DE); Reinhard Kohn, Berlin (DE); Jorg Schniedenharn, Berlin (DE)

Correspondence Address: STAAS & HALSEY LLP, SUITE 700, 1201 NEW YORK AVENUE, N.W., WASHINGTON, DC, 20005, US

(21) Appl. No.: 10/362,224

(22) PCT Filed: Aug. 21, 2001
(86) PCT No.: PCT/DE01/03184

(30) Foreign Application Priority Data
Aug. 21, 2000 (DE) 10040821.4

(51) Int. Cl. H04Q 7/00

(52) U.S. Cl. 370/328

(57) ABSTRACT

According to the inventive method for controlling access in a radio communications system, several subscriber stations (MS1, MS2) transmit a respective access sequence (SYNC1) to a base station (BS) of the radio communications system on a channel for random access (RACH). Afterwards, the radio communications system signals a selection of a subscriber station (MS1) on another channel (FPACH). The selected subscriber station (MS1) can subsequently transmit additional sequences to the base station (BS) on a physical access channel (PRACH). A known relationship between the access sequences (SYNC1) and the physical channels distinctively exists, and at least two physical access channels (PRACH) are assigned to another channel (FPACH).

The invention relates to a method for access control in a radio communication system, particularly in a mobile radio system

In radio communication systems, information (for example speech, image information or other data) is transmitted between a sending radio station and a receiving radio station (base station and mobile station) via a radio interface using electromagnetic waves. In this case, the electromagnetic waves are radiated at carrier frequencies which are in the frequency band provided for the respective system. For future mobile radio systems using CDMA (FDD mode) or TD/CDMA (TDD mode) transmission methods via the radio interface, for example the UMTS (Universal Mobile Telecommunication System) or other 3rd generation systems, frequencies in the frequency band around approximately 2000 MHz are envisaged.

To separate subscribers, the GSM mobile radio system, by way of example, involves the use of a time-division multiplex method (TDMA) to distinguish between the signal sources. A timeslot is used to transmit a radio block which can be evaluated separately from other radio blocks at the reception end. From the GSM mobile radio system, it is also known practice to send an access block in the uplink for the purpose of resource allocation. In this way, a subscriber station signals to the network that it wants to set up a connection. The timeslot reserved for the access blocks is accessed arbitrarily, however.

If a plurality of mobile radio stations send simultaneously in this timeslot, the access blocks are overlaid and might not be able to be detected by the receiving base station.

To implement a random access method (initial access) in a mobile radio system, various approaches are known. Both for UTRA FDD and for TDSCDMA (or UTRA TDD Low Chip Rate Option), two-stage random access procedures are used. This means that the subscriber station wishing to set up a connection to the network starts by sending a sequence (e.g. preamble in FDD, SYNC1 code in TDSCDMA). Only if this sequence is answered in the positive by the network (e.g. using the physical channels AICH (FDD) or FPACH (TDSCDMA)) is access continued and the actual random access message containing some relevant information is sent on the “physical random access channel” (PRACH).

In this case, the first sequence is selected by the subscriber station at random. On the basis of the first sequence chosen, the subscriber station must then know in which physical resources access is continued, i.e. in which downlink resources (AICH, FPACH) a response is made and in which uplink resources the subscriber station can send further access information. This is important in order firstly to make access efficient and secondly to avoid collisions between mobile radios which are accessing the PRACH simultaneously.

It is also necessary to consider that the subscriber station should not require too much time for the overall random access procedure, i.e. it should not have to wait too long for a response from the network or for confirmation that it can use the PRACH for transmission.

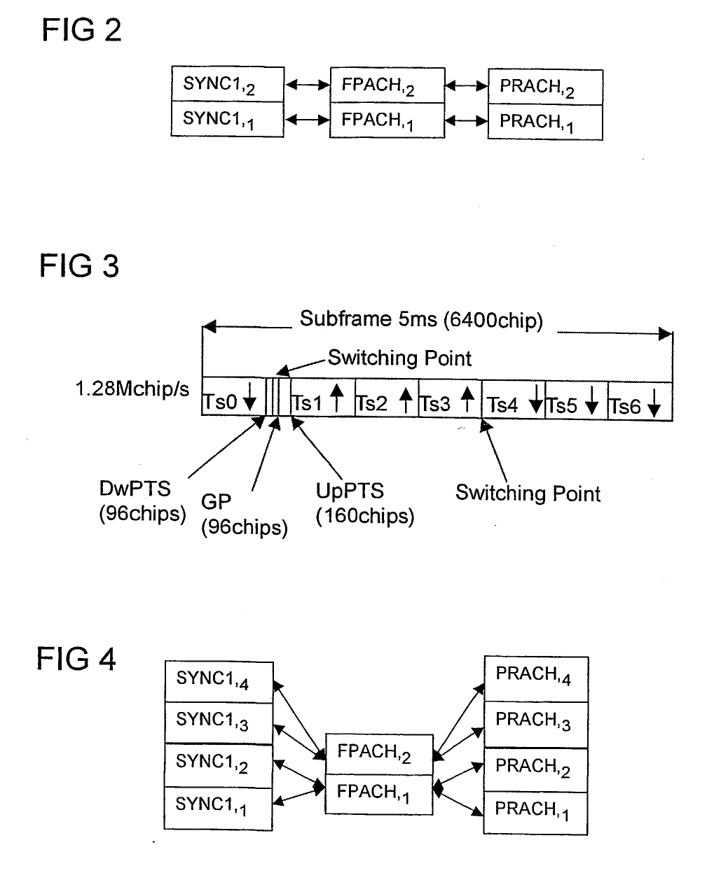

For the TDSCDMA system, it is proposed that a clear association be defined between the FPACH and PRACH resources used. In addition, there is an association between these FPACH/PRACH pairs and the SYNC1 codes used. This means that, at the instant at which a subscriber station selects a SYNC1 code, it is known which PPACH/FPACH pair is used (see FIG. 2 in this regard).

In the TDSCDMA system, a special “subframe structure” is used, with a subframe lasting 5 ms. Two subframes are joined together to form a frame of 10 ms (see FIG. 3 in this regard), which ensures compatibility with the other modes of the UMTS standard. Each subframe can be used to send a “SYNC1 sequence” in the “UpPTS” (Uplink Pilot Timeslot). For each radio cell, 8 SYNC1 sequences are approved, for example. Confirmation by the network in the form of an “FPACH acknowledgement” needs to be given within 4 subframes. In the FPACH, the SYNC1 sequence is referenced once again, and a response is given to this in order to identify the subscriber station clearly.

The solution proposed for the TDSCDMA system has the drawback that a subscriber station might need to wait until it can send its PRACH. By way of example, it is assumed that three subscriber stations send a respectively different SYNC1 sequence in a subframe. If these are all associated with the same PRACH/FPACH pair, then only one of these sequences can be given a response in the FPACH per subframe. Accordingly, the subscriber stations' response on the PRACH is delayed. The PRACH resources associated with the FPACH can only ever be accessed by one subscriber station at a time. In particular, the RACH can be sent distributed over a plurality of subframes, for example if there is interleaving over two or more subframes. In this case, the resources are blocked for individual access even longer.

The invention is based on the object of increasing the efficiency of access control. This object is achieved by the method having the features of patent claim 1. Advantageous developments of the invention can be found in the dependent patent claims.

The inventive method thus proposes, in the terminology of the systems described, assigning a single FPACH a plurality of PRACHs e.g. two PRACHs. This method can also be used to advantage in the same way in other radio communications systems using a two-stage access procedure.

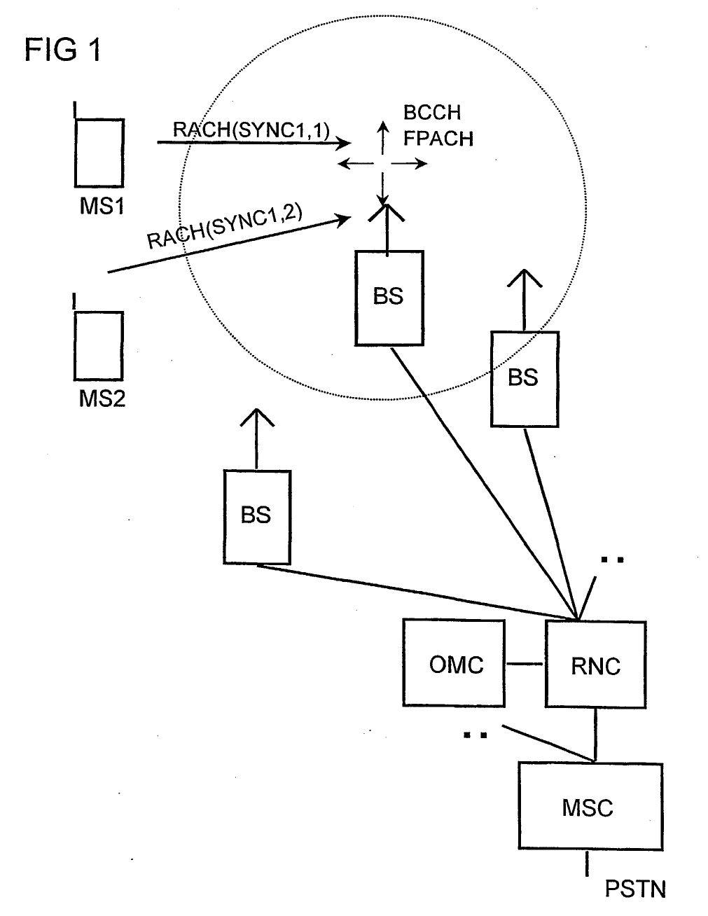

An example is explained in more detail with reference to FIGS. 1 and 4.

If, as FIG. 1 shows by way of example, two subscriber stations MS1, MS2 send two different SYNC1 sequences SYNC1,₁ and SYNC1,₂, in a subframe, then the same FPACH,₁, possibly in different subframes, is used to respond to both SYNC1 sequences within 4 subframes. In the subsequent subframes, both subscriber stations MS1, MS2 can then respond simultaneously in the PRACH, in each case using different resources PRACH,₁ and PRACH,₂. SYNC1 sequences, PRACHs and FPACHs can be assigned by using an item of system information to inform the subscriber stations of which SYNC1 codes belong to which PRACH/FPACH pair, with the same FPACH being able to belong to a plurality of PRACH/FPACH pairs.

Alternatively, a clear rule can be specified which stipulates the assignment of SYNC1 sequences, PRACHs and FPACHs and which is known to the network and/or to the subscriber stations.

In summary, the method described affords the advantages that utilization of the FPACH and PRACH resources is optimized, that the random access process is speeded up, and that the procedure can be adjusted on the basis of the RACH's interleaving size.

The mobile radio system shown in FIG. 1, as an example of a radio communication system, comprises a large number of mobile switching centers MSC which are networked to one another and set up access to a landline network PSTN. In addition, these mobile switching centers MSC are connected to at least one respective device RNC (Radio Network Controller) for controlling the base stations BS and for allocating radio resources, i.e. to a radio resource manager. Each of these devices RNC in turn allows a connection to at least one base station BS. Such a base station BS can use a radio interface to set up a connection to a subscriber station, e.g. mobile stations MS or other mobile and fixed terminals.

Each base station BS forms at least one radio cell.

An operation and maintenance center OMC implements control and maintenance functions for the mobile radio system and for parts thereof. The functionality of this structure can be transferred to other radio communication systems in which the invention can be used, particularly for subscriber access networks with wireless subscriber access and for base stations and subscriber stations operated in the unlicensed frequency range.

FIG. 1 shows, by way of example, connections for transmitting signaling information in the form of point-to-point connections between subscriber stations MS1, MS2 and a base station BS, and an organization channel BCCH (Broadcast Control Channel) in the form of a point-to-multipoint connection. The organization channel BCCH is transmitted by the base station BS using a known constant transmission power and contains, inter alia, details about the services provided in the radio cell and about the configuration of the channels in a radio interface. In the uplink UL, a random access channel RACH is provided for the subscriber stations MS1, MS2.

1. A method for access control in a radio communication system, in which
a plurality of subscriber stations (MS1, MS2) send a respective access sequence (SYNC1) to a base station (BS) in the radio communication system on a random access channel (RACH),
the radio communication system signals a subscriber station selection (MS1) on a further channel (FPACH) and
the selected subscriber station (MS1) subsequently sends further sequences to the base station (BS) on a physical access channel (PRACH), the further channel (FPACH) having at least two associated physical access channels (PRACH).

2. The method as claimed in claim 1, in which there is a known relationship between the access sequences (SYNC1) and the physical access channels (PRACH).

3. The method as claimed in claim 2, in which the relationship between a further channel (FPACH) and the physical access channels (PRACH) is signaled to the subscriber station using an item of system information.

4. The method as claimed in claim 1, in which the relationship between a further channel (FPACH) and the physical access channels (PRACH) is known to the network and/or to the subscriber stations.
